(19) United States
(12) Patent Application Publication
(10) Pub. No.: US 2018/0162699 A1
(43) Pub. Date: Jun. 14, 2018

(54) Elevator System Having a Pulley, the Contact Surface of Which Has an Anisotropic Structure

(71) Applicant: Inventio AG, Hergiswil (CH)

(72) Inventors: Andrea Cambruzzi, Zurich (CH); Volker Zapf, Obernau (CH)

(21) Appl. No.: 15/736,602

(22) PCT Filed: Jun. 7, 2016
(86) PCT No.: PCT/EP2016/062890

§ 371 Date: Dec. 14, 2017

(30) Foreign Application Priority Data
Jun. 17, 2015 (EP) 15172611.4

(51) Int. Cl. B66B 15/04; B66B 15/02

(52) U.S. Cl. CPC B66B 15/04; B66B 15/02

(57) ABSTRACT

In an elevator system, a belt-type suspension device is guided over at least one pulley. A contact surface of the pulley has an anisotropic structure for interacting with the belt-type suspension device. A friction coefficient between the suspension device and the contact surface in a circumferential direction of the pulley is greater than a friction coefficient between the suspension device and the contact surface in an axial direction of the pulley.

### FIELD

The present invention relates to an elevator system and in particular to an embodiment of a pulley in this elevator system.

### BACKGROUND

In elevator systems, steel cables are traditionally used as suspension means for carrying and/or driving an elevator car. According to a further development of such steel cables, belt-type suspension means are also used that have tension members and a sheathing arranged around the tension members. Such belt-type suspension means, similar to conventional steel cables, are guided around driving pulleys and deflection pulleys in the elevator system. However, in contrast to steel cables, belt-type suspension means are not guided in the pulleys or driving pulleys, but instead the belt-type suspension means essentially overlie the deflection pulleys and driving pulleys.

Due to the replacement of steel cables by belt-type suspension means with sheathed tension members, the interaction of pulleys with suspension means changes not only with respect to guiding the suspension means on the pulleys, but also with respect to the traction between the suspension means and the pulley surface. In principle a friction coefficient between pulley and suspension means increases if, instead of steel cables, suspension means having a sheathing made of plastic, for example polyurethane, are used. A higher friction coefficient may be desirable, on the one hand, to ensure sufficient traction, but, on the other hand, a higher friction coefficient may also have negative effects on the entire system because, for instance, lateral guidance of the suspension means on the pulley is rendered more difficult.

Thus it is desirable to be able to adjust the friction coefficient between pulley and suspension means to the specific requirements. WO 2013/172824 discloses coated pulleys for elevator systems. The friction coefficient between pulley and suspension means may thus be influenced by a selection of the coating. It is a drawback of this solution, however, that only a limited number of materials are available for describing steel pulleys, so that it is only possible to influence the friction coefficient in the context of the few available coating materials. In addition, these coatings of pulleys that are known in the prior art do not take into account the different requirements for pulleys in elevator systems.

### SUMMARY

It is therefore an object of the present invention to provide an elevator system in which the drawbacks that occur in the prior art do not exist. In addition, an elevator system is to be provided in which the different requirements for traction behavior between belt-type suspension means and pulleys are reconciled.

This object is attained using an elevator system in which first a belt-type suspension means is guided over at least one pulley. A contact surface of the pulley has an anisotropic structure. A friction coefficient between suspension means and contact surface in a circumferential direction of the pulley is greater than a friction coefficient between suspension means and contact surface in an axial direction of the pulley.

A pulley embodied in this manner for an elevator system has the advantage that because of this it is possible to best take into account the different requirements for traction behavior between belt-type suspension means and pulley. What a higher friction coefficient in the circumferential direction of the pulley attains is that traction for transmitting drive forces from the pulley to the belt-type suspension means, or from the belt-type suspension means, to the pulley may be optimally adjusted. On the other hand, what a lower friction coefficient in the axial direction of the pulley attains is that the belt-type suspension means can be guided better on the pulley. Specifically, it has been observed that friction between suspension means and pulley in the axial direction that is too high renders it more difficult to guide the suspension means laterally on the pulley. Since the lateral guidance of the belt-type suspension means on the pulley is improved, it is possible, for example, to prevent the suspension means from slipping laterally. In addition, a tolerance range for a diagonal pull of the suspension means on the pulley may be increased.

In one advantageous exemplary embodiment, a surface roughness in a circumferential direction of the pulley is greater than a surface roughness in an axial direction of the pulley. A greater surface roughness leads to a greater friction coefficient between suspension means and contact surface of the pulley, and lower surface roughness leads to a lower friction coefficient between suspension means and contact surface of the pulley.

In one advantageous exemplary embodiment, the surface roughness in the circumferential direction of the pulley is embodied such that, with a sheathing of the belt-type suspension means made of polyurethane, a friction coefficient p between 0.2 and 0.6, preferably between 0.3 and 0.5, particularly preferably between 0.35 and 0.45, results.

In one advantageous exemplary embodiment, the surface roughness in the axial direction of the pulley is embodied such that, with a sheathing of the belt-type suspension means made of polyurethane, a friction coefficient p between 0.05 and 0.45, preferably between 0.1 and 0.3, particularly preferably between 0.15 and 0.25, results.

This has the advantage that, depending on the configuration of an elevator system, optimal interaction between the belt-type suspension means and the pulley may be attained with respect to transmitting the drive forces and with respect to lateral guidance of the belt-type suspension means on the pulley.

In one advantageous exemplary embodiment, the anisotropic structure of the contact surface of the pulley is formed in an etching solution using a chemical or electrochemical process.

Such an electrochemical or chemical process in an etching solution has the advantage that it is cost effective and that the process permits the formation of a wide variety of anisotropic structures. Thus it is possible to optimally take into account the specific requirements of the various areas of application of pulleys in elevator systems.

In one alternative exemplary embodiment, the anisotropic structure of the contact surface of the pulley is formed using laser beam machining, electron beam machining, or ion beam machining.

In another alternative exemplary embodiment, the anisotropic structure of the contact surface of the pulley is formed using electric discharge machining or electrochemical machining.

In one advantageous exemplary embodiment, the contact surface of the pulley is embodied curved.

Such a curved embodiment of the pulley has the advantage that in this way better lateral guidance of the belt-type suspension means on the pulley may be attained.

In one alternative exemplary embodiment, the contact surface of the pulley is embodied contoured.

Such a contoured embodiment of the pulley has the advantage that in this way its pressure of the suspension means on the pulley may be attained.

In one advantageous refinement, the contact surface of the pulley is embodied complementary to a cross-section of a contact surface of the belt-type suspension means.

This has the advantage that in this way both better lateral guidance of the belt-type suspension means on the pulley and transmission of the drive forces may be optimized.

In one advantageous refinement, the contact surface of the pulley in the circumferential direction has a plurality of essentially V-shaped ribs and a plurality of essentially V-shaped grooves.

In one advantageous exemplary embodiment, the pulley is a driving pulley.

In one alternative exemplary embodiment, the pulley is a counterweight deflection roller or an elevator car deflection roller.

A plurality of pulleys or all pulleys in an elevator system may be selectively equipped with the surface features described herein.

In one advantageous exemplary embodiment, the contact surface of the pulley is made of steel.

This has the advantage that the methods described herein for processing the contact surface of the pulley may be tested and implemented cost effectively, in particular with steel.

In one advantageous refinement, the contact surface of the pulley is made of hardenable steel, wherein at least portions of the contact surface are hardened.

In one advantageous exemplary embodiment, the pulley has flanges.

Providing flanges on the pulleys has the advantage that this makes it more difficult for the belt-type suspension means on the pulley to slip laterally.

In principle, the suggested pulleys may be used at different locations in an elevator system and in different types of elevator systems. Such pulleys may be used in elevator systems having a counterweight and also in elevator systems that do not have a counterweight. Moreover, such pulleys may be used in elevator systems having different types of suspensions, such as, for example, 1:1 suspensions, 2:1 suspensions, and 4:1 suspensions. Pulleys may be arranged as deflection rollers on a counterweight or elevator car or in a shaft, or the pulley may be embodied as a driving pulley of a drive unit.

### DESCRIPTION OF THE DRAWINGS

The invention is explained in detail symbolically and by way of example in reference to figures. In the drawings,

FIG. 1 is a schematic representation of an exemplary elevator system;

FIG. 2A is a schematic representation of an exemplary pulley;

FIG. 2B is a schematic representation of an exemplary pulley;

FIG. 2C is a schematic representation of an exemplary suspension means; and,

FIG. 2D is a schematic representation of an exemplary pulley.

### DETAILED DESCRIPTION

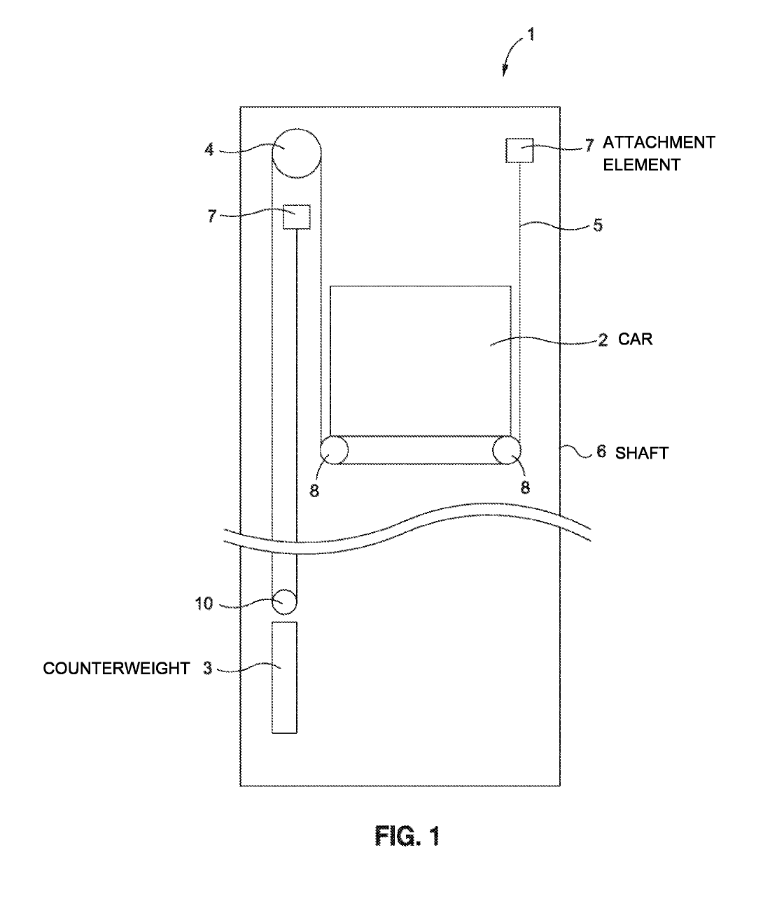

Depicted in FIG. 1 is an exemplary embodiment of an elevator system 1. The elevator system 1 comprises an elevator car 2, a counterweight 3, a drive unit 4, and a belt-type suspension means or device 5. The belt-type suspension means 5 is fixed in the elevator system 1 using a first suspension means attachment element 7, guided over a counterweight deflection roller 10, guided over a driving pulley of the drive unit 4, guided over two elevator car deflection rollers 8, and again attached in the elevator system 1 using a second suspension means attachment element 7.

In this exemplary embodiment the elevator system 1 is arranged in a shaft 6. In an alternative embodiment (not shown), the elevator system is not arranged in a shaft, but rather, for instance, on the exterior wall of a building.

The exemplary elevator system 1 in FIG. 1 includes a counterweight 3. In an alternative embodiment (not shown), the elevator system does not include a counterweight. In the exemplary elevator system 1 in FIG. 1, both counterweight 3 and elevator car 2 are suspended with a 2:1 suspension. In an alternative embodiment (not shown), both the counterweight and the elevator car may be suspended with a different translation ratio. In addition, numerous other embodiments of an elevator system are possible.

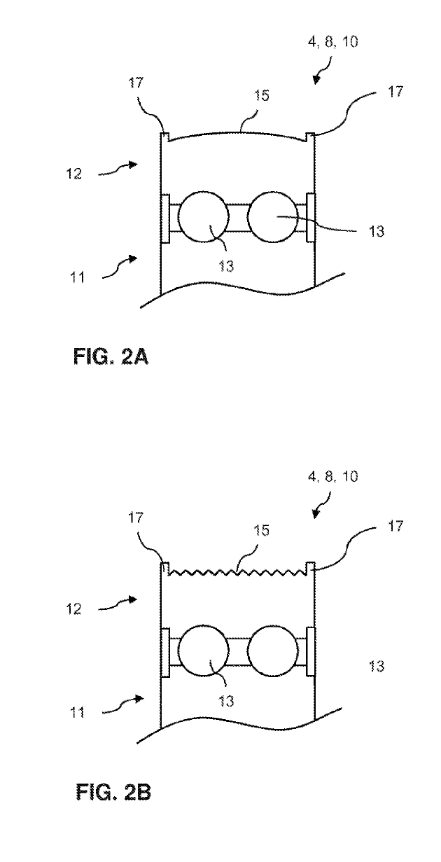

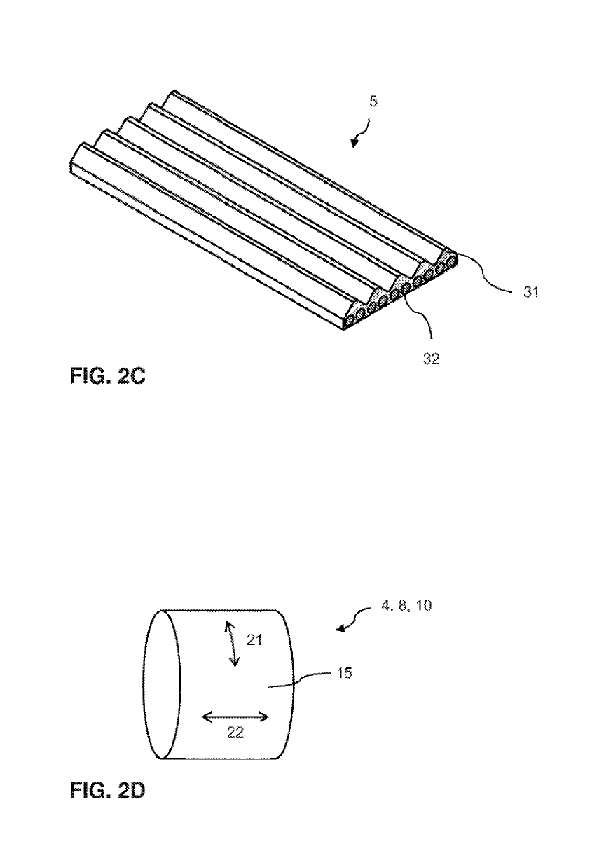

FIG. 2A schematically depicts an exemplary embodiment of a pulley 4, 8, 10. The figure illustrates parts of a cross-section of the pulley 4, 8, 10. The pulley 4, 8, 10 has an inner ring 11 and an outer ring 12. Roller elements 13 are arranged between the inner ring 11 and the outer ring 12. The outer ring 12 forms the contact surface 15 of the pulley 4, 8, 10.

The outer ring 12 has flanges 17 in this exemplary embodiment. Each of the flanges 17 is arranged connected on the side of the contact surface 15 so that it is possible to prevent the belt-type suspension means (not shown) from slipping laterally.

In this exemplary embodiment, the contact surface 15 is embodied curved. In this way in particular belt-type suspension means having a rectangular cross-section may be guided laterally on the pulley 4, 8, 10.

FIG. 2B depicts another exemplary embodiment of a pulley 4, 8, 10. Again, part of a cross-section of the pulley 4, 8, 10 is depicted. In contrast to the pulley from FIG. 2A, in this exemplary embodiment the contact surface 15 is embodied contoured. The contact surface 15 has a plurality of essentially V-shaped ribs and a plurality of essentially V-shaped grooves in a circumferential direction. The contact surface 15 is embodied complementary to a traction surface of the belt-type suspension means (not shown). On the one hand, the ribs and grooves of the contact surface 15 increase the traction between the belt-type suspension means and the pulley 4, 8, 10, and on the other hand guide the belt-type suspension means laterally on the pulley 4, 8, 10.

FIG. 2C depicts section of an exemplary embodiment of a suspension means 5. The suspension means 5 includes a plurality of tension members 32 that are arranged adjacent to one another in a common plane and that are surrounded by a common sheath 31. In this example, the suspension means 5 is equipped with longitudinal ribs on a traction side. Such longitudinal ribs improve the traction behavior of the suspension means 5 on the driving pulley 4 and also facilitate a lateral guidance of the suspension means 5 on driving pulley 4. However, the suspension means 5 may also be designed differently, for example, without longitudinal ribs or with a different number or a different arrangement of tension members 32.

FIG. 2D depicts another exemplary embodiment of a pulley 4, 8, 10. A circumferential direction 21 and an axial direction 22 are identified on the contact surface 15 on the depicted pulley 4, 8, 10. The anisotropic structure of the contact surface 15 is not visible in this exemplary depiction because such small structures are not visible at the scale selected for the pulley 4, 8, 10.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. An elevator system having a belt-type suspension means guided over at least one pulley, the at least pulley comprising:
a contact surface extending in a circumferential direction about the at least one pulley and having an anisotropic structure for interacting with the suspension means, wherein the anisotropic structure generates a first friction coefficient between the suspension means and the contact surface in the circumferential direction of the at least one pulley that is greater than a second friction coefficient generated between the suspension means and the contact surface in an axial direction of the at least one pulley.

18. The elevator system according to claim 17 wherein a first surface roughness of the contact surface in the circumferential direction of the at least one pulley is greater than a second surface roughness of the contact surface in the axial direction of the at least one pulley.

19. The elevator system according to claim 18 wherein the first surface roughness of the contact surface when in contact with a sheathing of the suspension means being formed of a polyurethane material generates the first friction coefficient in a range between 0.2 and 0.6.

20. The elevator system according to claim 18 wherein the first surface roughness of the contact surface when in contact with a sheathing of the suspension means being formed of a polyurethane material generates the first friction coefficient in a range between 0.3 and 0.5.

21. The elevator system according to claim 18 wherein the first surface roughness of the contact surface when in contact with a sheathing of the suspension means being formed of a polyurethane material generates the first friction coefficient in a range between 0.35 and 0.45.

22. The elevator system according to claim 18 wherein the second surface roughness of the contact surface when in contact with a sheathing of the suspension means being formed of a polyurethane material generates the second friction coefficient between 0.05 and 0.4.

23. The elevator system according to claim 18 wherein the second surface roughness of the contact surface when in contact with a sheathing of the suspension means being formed of a polyurethane material generates the second friction coefficient between 0.1 and 0.3.

24. The elevator system according to claim 18 wherein the second surface roughness of the contact surface when in contact with a sheathing of the suspension means being formed of a polyurethane material generates the second friction coefficient between 0.15 and 0.25.

25. The elevator system according to claim 17 wherein the anisotropic structure of the contact surface is formed by applying an etching solution using electric discharge machining or electrochemical machining.

26. The elevator system according to claim 17 wherein the anisotropic structure of the contact surface is formed using a chemical or electrochemical process.

27. The elevator system according to claim 17 wherein the anisotropic structure of the contact surface is formed using laser beam machining, electron beam machining, or ion beam machining.

28. The elevator system according to claim 17 wherein the contact surface is curved in the axial direction.

29. The elevator system according to claim 17 wherein the contact surface is contoured.

30. The elevator system according to claim 29 wherein the contact surface is formed complementary to a cross-section of a contact surface of the suspension means.

31. The elevator system according to claim 30 wherein the contact surface has a plurality of V-shaped ribs and a plurality of V-shaped grooves extending in the circumferential direction.

32. The elevator system according to claim 17 wherein the pulley is a driving pulley.

33. The elevator system according to claim 17 wherein the pulley is a counterweight deflection roller or an elevator car deflection roller.

34. The elevator system according to claim 17 wherein the contact surface is formed of a steel material.

35. The elevator system according to claim 34 wherein the contact surface is formed of a hardenable steel material, and at least portions of the contact surface are hardened.

36. The elevator system according to claim 17 wherein the pulley includes flanges arranged at opposite sides of the contact surface.
